(19) United States
(12) Patent Application Publication
(10) Pub. No.: US 2013/0339224 A1
(43) Pub. Date: Dec. 19, 2013

(54) MONEY TRANSACTION SYSTEM AND A METHOD THERETO

(71) Applicant: Aitico Oy, Lahti (FI)

(72) Inventor: Evgeny LYKOV, Metsakyla (FI)

(21) Appl. No.: 13/918,130

(22) Filed: Jun. 14, 2013

(30) Foreign Application Priority Data
Jun. 15, 2012 (FI) PCT/FI2012/050614

(51) Int. Cl. G06Q 20/10; G06Q 20/22

(52) U.S. Cl. CPC G06Q 20/10; G06Q 20/223
USPC 705/39

(57) ABSTRACT

A system and method for providing money transaction between a sender and a recipient, wherein within the system at least one transaction device is configured to receive money inserted therein, determine its value, determine a transaction code for the money and deliver information on at least the value of the inserted money and the transaction code to at least one server. Additionally, the transaction device is configured to receive a transaction code, request, by delivering the received transaction code to the server maintaining money transaction related information, if a corresponding transaction code with information on the value of inserted money is stored in the server, and if a match is found receive from the server an authorization to output a corresponding amount of money in cash as indicated in the information in the server in connection to the transaction code. Finally, the transaction device outputs the corresponding amount of money.

### TECHNICAL FIELD

The invention concerns in general the technical field of ICT technology. Especially the invention concerns an arrangement for performing money transaction from a sender to a recipient over communication network.

### BACKGROUND OF THE INVENTION

There exist several technical solutions for transferring money from a first party (sender) to a second party (recipient). A typical solution is that the sender access to his or her money account and orders the provider of the account to transfer money to an account of the recipient. The provider of the money accounts and operation relating thereto is usually a bank, which also offers other financial related services to customers. The sender gives the money transfer order either by means of ATM (Automated Teller Machine) or utilizing an Internet service provided by the bank. In case of ATM the sender needs to access his or her bank account by utilizing a bank card accessible with a PIN (Personal Identification Number). In case of Internet payment, in turn, the sender access to his or her account by means of credentials, such as a username and a password.

In a technical sense a secure network and secured network elements are needed for the money transfer. This is normally achieved by using highly encrypted communication channels as well as different types of authentication methods of the users. Additionally, the sender and recipient are identified by the service provider, such as a bank, when taken as customers. The banks may also set limitations to conditions of use of the accounts, such as limitation to the amount of money that can be transferred at a time, for example.

Mobile communication has enabled several other ways of transferring money. For example patent document IN2010CH010772A discloses a solution in which money transfer can be initiated by a mobile communication device. The sender i.e. the party initiating the money transfer inserts an access code by means of the mobile communication device in order to initiate a money transfer from a bank account of the sender. The system creates a withdrawal code, which is transmitted to a recipient's mobile communication device. The recipient may withdraw the money from an ATM by inserting the withdrawal code.

The main drawback of the prior art solutions is that there is always need to have a customer relationship to the service provider. In practice this means that a bank account is created for the customer. The bank account is the central element of different service concepts being offered to the customer. However, it is not possible to transfer money from a first party to a second party without having any customer relationship to the bank. Especially, in developing countries where the bank system is not necessarily working properly and people does not have bank accounts there is no other way to transfer money but to meet personally.

### SUMMARY OF THE INVENTION

An objective of the invention is to provide a system and a method for enabling a money transaction between a sender and a recipient. Another objective of the invention is that the system and method enabling the money transaction are easily available to any user.

The objects of the invention are reached by a system and a method as defined by the respective independent claims.

According to a first aspect, a system for providing money transaction between a sender and a recipient, wherein the system comprises at least one transaction device and at least one server for maintaining money transaction related information, is introduced. Within the system the at least one transaction device is configured to receive money inserted in the transaction device by a sender, determine the value of the inserted money, determine a transaction code for the inserted money and deliver information on at least the value of the inserted money and the determined transaction code to the at least one server, which is configured to create a data record for the money transaction and to maintain money transaction related information. Further, according to the first aspect, within the system at least one transaction device is further configured to receive a transaction code from a recipient, request, by delivering the received transaction code to the at least one server maintaining money transaction related information, if a corresponding transaction code with information on the value of inserted money is stored in the at least one server, and if a match is found, to receive, from the at least one server in response to the request, an authorization to output a corresponding amount of money in cash as indicated in the information in the server in connection to the transaction code and output the corresponding amount of money in the transaction device.

The at least one transaction device may further be configured to output the determined transaction code to the sender by means of I/O means of the at least one transaction device in response to the determination of the transaction code. The determination of the transaction code may comprise one of the following: creation of the transaction code in the transaction device, creation of the transaction code in the at least one server, receipt of the transaction code from the sender by means of I/O means of the transaction device, receipt of the transaction code from a mobile terminal of the sender over a communication channel between the mobile terminal and the transaction device.

The transaction device may further comprise a counterfeit detection means for checking if the inserted money is counterfeit or not during the step of determination the value of the inserted money.

The transaction device may also comprise an interface for communicating wirelessly with a mobile terminal. The transaction code may be wirelessly transferred from the transaction device to the mobile terminal of the sender. Alternatively or in addition, the transaction code may be wirelessly transferred to the transaction device from the mobile terminal of the recipient. The communication between the transaction device and the mobile terminal may be arranged to be encrypted.

The at least one server may further be configured to store user related PIN arranged to be used in money transaction. Furthermore, the transaction device may be configured to deliver a confirmation message to the at least one server in response to output of the money.

The at least one server may be configured to delete information relating to the completed transaction stored in a memory of the server in response to a receipt of the confirmation message. The at least one server may also be configured to store information on the completed transaction.

The at least one server may further be configured to check if the same transaction code already exist in the server as sent by a transaction device in the context of delivery of transaction information. The at least one server may be configured to request a re-determination of the transaction code from the transaction device delivering the transaction related information if the match is found.

The transaction device may be configured to request at least one of the following from the sender: sender's contact detail, recipient's contact detail. The system may be configured to deliver a message to at least the sender or the recipient of money if a predetermined time limit for withdrawal of the money is exceeded.

The transaction device may comprise identification means for receiving at least some identification information on the user of the transaction device to be stored in a context of the transaction related information.

According to a second aspect, a method for providing money transaction between a sender and a recipient is introduced, wherein money inserted in a transaction device by a sender is received, the value of the inserted money is determined, a transaction code for the inserted money is determined and information on at least the value of the inserted money and the determined transaction code is delivered to at least one server, which is configured to create a data record for the money transaction and to maintain money transaction related information. Further, according to the second aspect a transaction code is received from a recipient, it is requested, by delivering the received transaction code to the at least one server maintaining money transaction related information, if a corresponding transaction code with information on the value of inserted money is stored in the at least one server, and if a match is found, it is received, from the at least one server in response to the request, an authorization to output a corresponding amount of money in cash as indicated in the information in the server in connection to the transaction code and the corresponding amount of money is outputted in a transaction device.

The method may comprise a step of outputting the determined transaction code to the sender by means of I/O means of the at least one transaction device in response to the determination of the transaction code. The determination of the transaction code may comprise one of the following: creating the transaction code in the transaction device, creating the transaction code in the at least one server, receiving the transaction code from the sender by means of I/O means of the transaction device, receiving the transaction code from a mobile terminal of the sender over a communication channel between the mobile terminal and the transaction device.

The method may further comprise a step of checking if the inserted money is counterfeit or not.

The method may also comprise wireless communication between the transaction device and a mobile terminal. For example, the transaction code may wirelessly be transferred from the transaction device to the mobile terminal of the sender. The transaction code may wirelessly be transferred to the transaction device from the mobile terminal of the recipient. The communication between the transaction device and the mobile terminal may be encrypted.

The method may comprise a storing of user related PIN arranged to be used in money transaction in the at least one server in a step of management of transaction information. Further, in the step of management of transaction information a confirmation message may be delivered to the at least one server in response to output of the money. A further step of deleting information relating to the completed transaction stored in a memory of the server may be arranged in response to a receipt of the confirmation message. Alternatively or in addition, the method may comprise a further step of storing information on the completed transaction.

The method may further comprise a step of checking, by the at least one server, if the same transaction code already exist in the server as sent by a transaction device in the context of delivery of transaction information. It may also be arranged, that the method further comprises a step of requesting, by the at least one server, a re-determination of the transaction code from the transaction device delivering the transaction related information if the match is found.

The method may also comprise a step of requesting, by the transaction device, at least one of the following from the sender: sender's contact detail, recipient's contact detail. A delivery of a message to at least the sender or the recipient of money if a predetermined time limit for withdrawal of the money is exceeded may be arranged.

Alternatively or in addition, the method may further comprise a step of receiving at least some identification information on the user of the transaction device to be stored in a context of the transaction related information by means of identification means of the transaction device.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a system according to the invention,

FIG. 2a-2b illustrate a transaction device according to an embodiment of the invention,

FIG. 3 illustrates a method according to an embodiment of the invention, and

FIG. 4 illustrates a server according to an embodiment of the invention.

### DETAILED DESCRIPTION OF THE INVENTION AND ITS ADVANTAGEOUS EMBODIMENTS

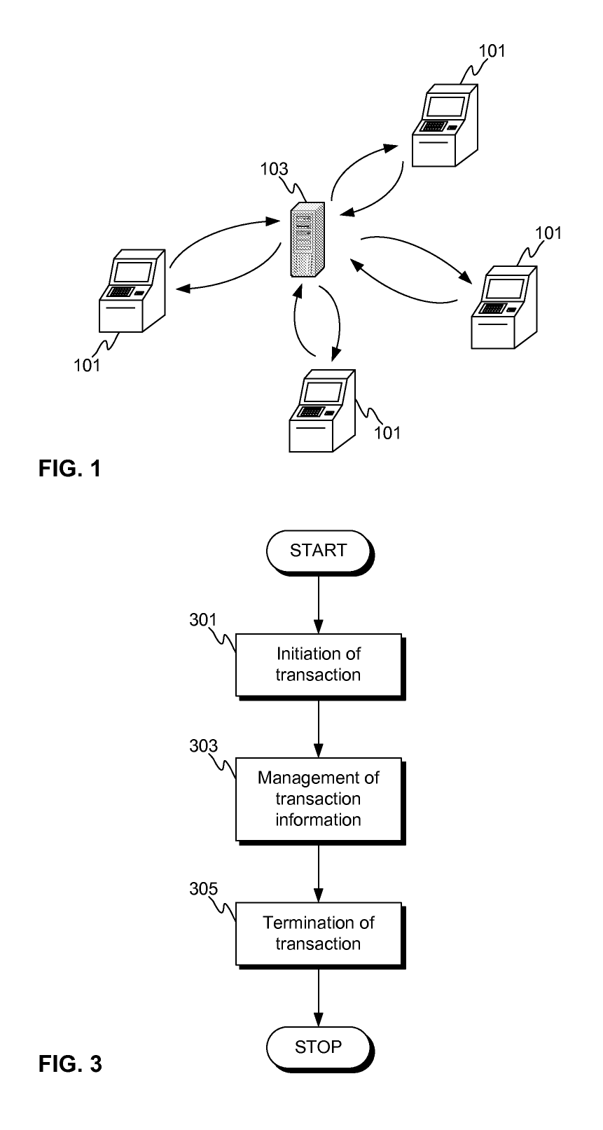

The system according to the invention is illustrated in FIG. 1. The system comprises one or more transaction devices 101 and one or more servers 103. The one or more transaction devices 101 are arranged to be used by the users of the systems and capable of communicating with at least the one or more servers 103 and with the one or more other transaction devices 101 if necessary.

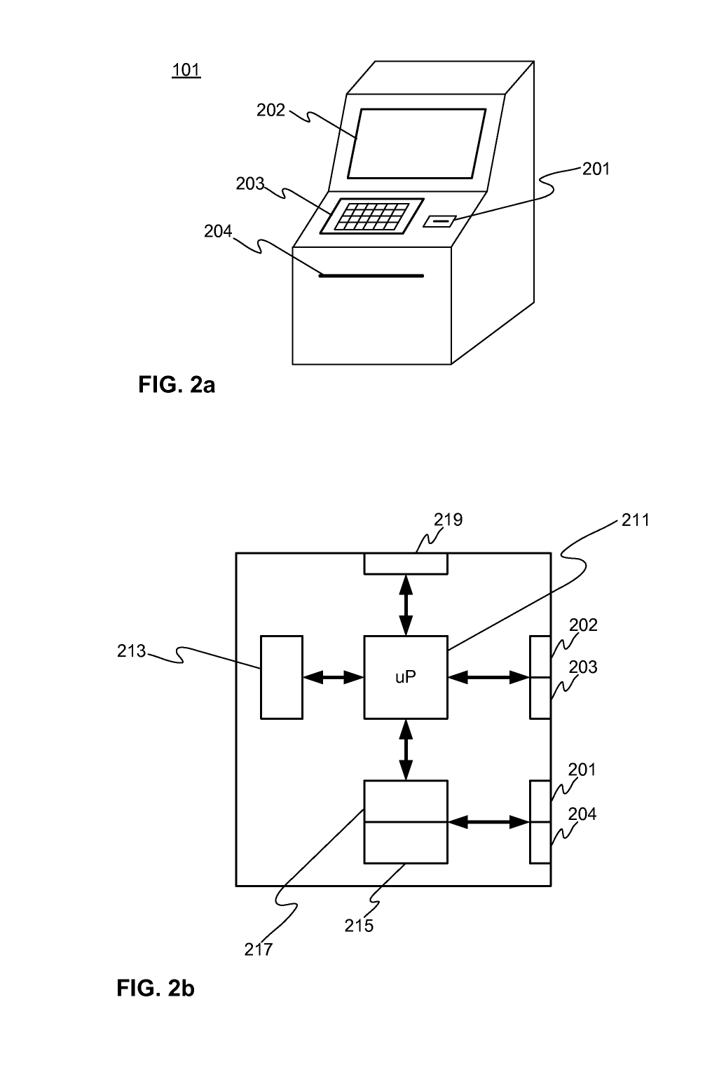

The transaction device 101 is a device, which is configured to operate as a user interface for the money transaction system. FIG. 2a illustrates an exemplified appearance of a transaction device 101. The transaction device 101 may comprise a feed opening 201 for inserting money into the transaction device. Additionally, the transaction device 101 may comprise I/O means, such as a display 202 and keyboard 203, for inputting and outputting information. Furthermore, the transaction device may comprise output port 204 for outputting e.g. money and receipt to the user of the transaction device 101.

FIG. 2b illustrates at least some internal elements of a transaction device 101 according to an embodiment of the invention. The transaction device 101 may comprise processing element 211 consisting of one or more processors. Further, the transaction device 101 may comprise memory element 213 consisting of one or more RAM (Random-Access Memory) and/or ROM (Read-Only Memory) units coupled either directly or indirectly to the transaction device 101. Software is stored in the memory elements of the transaction device 101 for providing operational instructions for the transaction device 101 and any other entity, when at least piece of software is executed by the processing element 211 of the transaction device 101. The I/O means, such as a display 202 and keyboard 203, are configured to be controlled by the processing element 211 so that information can be inputted and outputted. The transaction device 101 may also comprise counterfeit detection means 215 and money calculation means 217, which are coupled to feed opening 201 so that the inserted money can be conveyed to the counterfeit detection means 215 and calculation means 217. All mechanical elements, which are possibly needed, are not illustrated in FIG. 2b. Further, e.g. the calculation means 217 may be coupled to output port 204 in order to enable outputting a correct amount of money. Any storage elements for money are not illustrated in FIG. 2b. The operation of the counterfeit detection means 215 and calculation means 217 may be controlled by the processing element 211 and information may be transferred between these elements. Additionally, the transaction device 101 may comprise necessary external interfaces 219, implemented by e.g. modems, for communicating with at least some other elements belonging to the system. For example, the transaction device 101 may comprise short range radio modems for establishing a communication channel to a mobile terminal of a user of the system or wired modem for establishing a communication channel to any other network node, such as to a server 103, in the system.

Furthermore, the transaction device 101 may be equipped with identification means, such as a camera or any similar means, for receiving identification information from the user of the transaction device 101. For example, it may be arranged that the transaction device 101 is configured to take an image by means of the camera on every user of the transaction device 101. Moreover, the digital image information may be coupled to other information, which is composed on any operation, such as money transfer transaction, performed by the transaction device 101. Alternatively or in addition, the transaction device 101 may be equipped with a scanner by means of which it is possible to scan any information provided by the user of the transaction device 101. Such piece of information is e.g. identification card or passport of the user of the device. The scanned information may also be stored in a context of any other information composed on any operation performed by the transaction device 101. Alternatively or in addition, the transaction device 101 may be arranged to communicate with an entity to confirm the validity of the identification information. For example, the transaction device 101 may be coupled to ID database and by delivering the identification information received from the user to the ID database, the transaction device 101 may receive a confirmation that the user is trusted one. The identification may be performed to both the sender and the recipient of the money.

Any similar means, such as fingerprint scanner, may be used for gaining some sort of identification of the user of the transaction device 101. The identification means may be used either for the sender of the money, the recipient of the money or both of them. The information received by means of the identification means may be stored either temporarily or permanently in the system. Necessary prompting and guidance in order to achieve the identification information from the user of the transaction device 101 is to be implemented in the transaction device 101. The identification means may be integrated in the transaction device 101 or it may be a separate device coupled either in wired means or wirelessly to the transaction device 101.

The transaction device 101 is configured to receive and output money in cash. The user of the system enters to the transaction device 101 and inserts money in cash to a feed opening 201 of the transaction device 101. The transaction device 101 is configured to detect the inserted money in cash in the feed opening 201 and in response to the detection the transaction device 101 may convey the inserted money inside the transaction device 101 for at least counterfeit check and determination of the amount of money. The counterfeit check may be based on e.g. detection of identifiers from the banknote or even from a coin if coin insertion is enabled in the transaction device 101. The identifiers of the money may be defined in a memory element 213 of the transaction device 101 so that when the counterfeit check is performed the instructions and identifiers are retrieved from the memory 213 by the processing element 211 of the transaction device 101. The identifiers of the money may be scanned by means of counterfeit detection means 215, like infrared light source and a detector thereto, which may provide necessary information to the processing element 211 for judging if the inserted money is counterfeit or not.

In addition to counterfeit detection means 215 the transaction device 101 is configured to determine the value of the inserted money by means of calculation means 217. The determination may at least partly be based on the identification of the identifiers of the inserted money during the counterfeit check or any other ways of defining the value of the money. The transaction device 101 may be configured to output the value of the money to the user, who has inserted the money into the transaction device 101. The output of information may be arranged by means of I/O means, such as display 202 and/or voice message, of the transaction device 101. The transaction device 101 may further be configured to prompt the user that he or she accepts the value as defined. If the user does not accept the defined value and inputs such indication to the transaction device 101, the transaction device 101 may be configured to return the inserted money. Similarly, if the transaction device 101 defines that the inserted money is counterfeited, it may directly return the inserted material. Alternatively, the transaction device 101, in case of detection the counterfeit, may be configured to announce the user of the detection of counterfeit and keep the inserted material. Further, the transaction device 101 may be arranged to photograph the user and make an alarm to a predefined entity if the transaction device 101 is equipped with a camera and alarm setting means. If the user accepts the value of money as output by the transaction device 101 with an action defined for indicating the acceptance, such as pushing a button in a keyboard 203, the transaction device 101 is configured to determine a transaction code for the user action of inserting the money. The transaction code may be determined by means of random number generator, for example, implemented in the transaction device 101. The transaction code may be output to the user with I/O means of the transaction device 101. For example, the determined transaction code may be output by displaying it on the display 202 of the transaction device 101 so that the user may write it down. Alternatively or in addition the transaction code may be printed out by the transaction device 101. Furthermore, the transaction device 101 may comprise an interface by means of which it can be arranged to communicate, either directly with e.g. short range wireless communication technique or indirectly through one or more network elements and/or networks, with a mobile terminal of the user i.e. the sender. The short range wireless communication technique may be e.g. Bluetooth, WLAN or even NFC (Near Field Communication) or any combination of these. In order to establish the communication channel to the user terminal the user may need to enable a short range communication modem in the terminal and accept any request from the transaction terminal or in case of indirect communication over e.g. telecommunication network the user may need to provide a phone number to the transaction device 101 e.g. by means of I/O means of the transaction device 101.

In addition to providing a transaction code to the sender the transaction device 101 may be configured to determine one or more messages for delivering information on the inserted money transaction to at least one server 103 belonging to the system. The transaction device 101 is at least configured to deliver information on the value of the inserted money and the transaction code determined for the inserted money transaction. A data record comprising the transaction information is created in the at least one server 103. The server 103 comprises memory means, such as one or more RAM and/or ROM elements for storing the transaction information. The transaction information is stored in such a manner that each of the transaction information is identifiable from each other. According to an embodiment of the invention the transaction information is identifiable on the basis of the transaction code. Thus, it is required that the system is configured to determine a different transaction code for each transaction. This can be arranged e.g. in such a manner that each of the transaction device 101 belonging to the system comprise its own transaction code system, such as code number space, the status of which is maintained in the transaction device 101 in question. Alternatively in case of not having a dedicated transaction code system for each of the transaction device, the server 103 may be arranged to check if such a transaction code already exists in the server, which is just sent by a transaction device 101. If a match is found, the server 103 may be configured to inform the transaction device 101 sending the transaction information that the server is already storing information comprising the same transaction code and the transaction device 101 needs to determine a new transaction code. The determined new code may also be outputted to the sender of the money. According to some embodiment of the invention the transaction code is arranged to be centrally determined by at least one server 103. By means of such an arrangement it is easy to check internally that transaction codes differ from each other. In this kind of arrangement the transaction devices 101 are configured to communicate with at least one server 103 when a transaction is initiated by insertion of money into the transaction device 101 in order to receive a transaction code for the transaction from the server 103. The communication comprises at least a request for a transaction code and response to the request.

The determined transaction code output to the sender by the transaction device 101 may be delivered to an intended recipient of the money by the sender of the money. This can be arranged by means of telecommunication connection, such as by establishing a voice call between the sender and the recipient or by utilizing the messaging features, such as SMS (Short Message Service), provided by a telecommunication network. As the recipient receives the transaction code he or she may go to any of the transaction devices 101 belonging to the system and by inserting the transaction code by means of I/O means of the transaction device 101 withdraw an amount of money corresponding to the information stored in the context of the transaction code in the server 103. More specifically, the transaction device 101 is configured, in response to receipt of information on an transaction code, to establish a communication channel to at least one server 103 for requesting, by delivering the inserted transaction code, if the at least one server 103 comprises stored transaction related information corresponding to the inserted transaction code. If a match is found, the at least one server 103 is configured to acknowledge the transaction device 101 on that and convey information on the amount of money to be output by the transaction device 101 and thus authorize the transaction device 101 to output the amount of money. The transaction device 101 is configured, in response to the receipt of the acknowledgement message, to determine the amount of money in cash by utilizing internal money calculation means 217 and output the said amount of money in cash to the recipient through an output port 204 of the transaction device 101. Furthermore, the transaction device 101 may be configured to deliver a confirmation message to the at least one server 103 in response to the output of money. The delivery of confirmation message may initiate a deletion of information in the at least one server as regards to the completed transaction. Alternatively or in addition, the at least one server 103 may be configured to store information on the completed transaction in long term.

According to an embodiment of the invention the sender is requested to insert recipient's contact detail, such as a mobile phone number, during the context of insertion of money to the transaction device 101. The request of recipient's contact detail may be displayed on the display 202 of the transaction device 101 at the same time, when the acceptance for the defined value of money is prompted to the sender. When the recipients contact detail is received the piece of information is transferred to the at least one server 103 with the other transaction related information as described before. It can be arranged that if the recipient's contact detail is inserted, the system is configured to deliver an announcement by means of telecommunication connection to the recipient that money is deposited for him or her. In addition, the announcement may comprise the transaction code by means of which the money can be withdrawn in a transaction device 101. The announcement may also comprise some further information, such as time limit when the money shall be withdrawn at latest and/or request for confirmation of the receipt of the announcement.

According to some embodiment of the invention the sender is requested to insert his or her contact detail, such as a mobile phone number, during the context of initiation of a transaction i.e. insertion of money to the transaction device 101. The request of sender's contact detail may be displayed on the display 202 of the transaction device 101 at the same time, when the acceptance for the defined value of money is prompted to the sender. When the sender's contact detail is received the system may be configured to transfer the piece of information to the at least one server 103 belonging to the system with the other transaction related information as described before. The system may be arranged to send a confirmation message on the receipt of the money to the sender with any other information, such as the transaction code. The sender may forward the information on the transaction code either directly or indirectly to the intended recipient of the money. The system may also be configured to compose an announcement message to be sent to the sender of the money, when the recipient withdraws the money from the system. In practice, this can be arranged so that when the server 103 acknowledges the transaction device 101 from which a transaction code is received that the money can be output, the at least one server 103 also composes and delivers an announcement message to the sender of the money. Furthermore, the system may be configured to monitor the withdrawal of the money in a time sense. For example, a time limit for withdrawal can be set to the system, stored preferably in a server 103. If the money is not withdrawn within the time limit, the system may be configured to detect this and announce the sender of money on this. The system may also be configured to inform the sender of the money that he or she shall withdraw the money during another time limit. By means of this the amount of pending transactions can be maintained on an acceptable level in the system. In practice the monitoring of time limit can be arranged by setting a time stamp for the transaction. As an internal clock is arranged in the system it is possible to monitor the duration of the transaction information maintenance in the server 103. At least one of the servers 103 can be arranged to be responsible for the monitoring of the time limit.

According to some further embodiment of the invention the sender is requested to insert his or her contact detail and a contact detail of the intended recipient of the money. The contact detail may be a mobile phone number, for example. The request to insert sender's and recipient's contact detail may be displayed on the display 202 of the transaction device 101 at the same time, when the acceptance for the defined value of money is prompted to the sender. When the sender's and recipient's contact detail is received the system may be configured to transfer the piece of information to the at least one server 103 belonging to the system with the other transaction related information as described before. The system may be arranged to send a confirmation message on the receipt of the money to the sender with any other information, such as the transaction code. Additionally, the system may be arranged to deliver a notification to the intended recipient of the money where the notification comprises at least the transaction code. The confirmation message and the notification message may be composed by the at least one server 103, when the server 103 receives required transaction related information from a transaction device 101. The system may be configured to compose an announcement message to be sent to the sender of the money, when the recipient withdraws the money from the system. In practice, this can be arranged so that when the server 103 acknowledges the transaction device 101 from which a transaction code is received that the money can be output, the at least one server 103 also composes and delivers an announcement message to the sender of the money. Furthermore, the system may be configured to monitor the withdrawal of the money in a time sense. If it is noticed that during a predetermined time limit the money is not withdrawn the system may be configured to compose a notification message to the sender and the recipient. The notification message may comprise reminder information on the money pending in the system. Furthermore, it may comprise some detailed information on the transaction, such as re-sent transaction code as well as some information by when the money shall be withdrawn. Additionally, it can be arranged so that when a predetermined time limit is exceeded, also the sender of the money may withdraw the money out of the system when this is initially prevented. If the sender withdraws the money, the system may be configured to compose and deliver a message to the intended recipient on this.

In order to improve the safety of the system a solution in which the user terminal is directly and wirelessly communicating with a transaction device 101 is introduced. As already described the transaction device 101 may be equipped with a wireless communication means, such as short range wireless modems and other necessary elements like antenna. According to an embodiment of the invention it may be required that the user needs to download an application to his or her mobile terminal in order to utilize the wireless communication capabilities of a transaction device 101 and thus the service. The application may be downloaded from the Internet or from the transaction device 101 by establishing a wireless connection. As the application is downloaded the user may be requested to register to the system by inserting some personal identification information. In response to this the system may provide a personal identification number (PIN) to be used in the context of the service. Alternatively, the system may provide a PIN to every user, who downloads and installs the application to the mobile terminal. In some implementations the user may define the PIN code on his or her own. It may be configured that the wireless communication between the application residing in the mobile terminal and the transaction device 101 is encrypted and any piece of information, such as a transaction code, transferred to or from the mobile terminal is encrypted. In order to read the transaction code in plain text the user needs to insert the PIN. According to some embodiment the intended recipient of the money may receive the transaction code as encrypted. When the recipient wants to withdraw the money, he or she establishes a short range communication link between his or her mobile terminal and the transaction device 101 intended to be used for the withdrawal. By selecting a withdrawal option either from the mobile terminal (I/O means of the terminal) or from the transaction device 101 the application residing in the mobile terminal may be configured to transfer transaction related piece of information, such as transaction code, to the transaction device 101. The piece of information may be transferred in an encrypted form. Additionally, the application may transfer recipient's PIN code related information. Either it is the encrypted PIN code or such information by means of which the transaction device 101, or any other element belonging either directly or indirectly to the system, may define the PIN code for a specific recipient. In such a case the transaction device 101 is configured to request the PIN code from the user when PIN code for the user is defined. If the PIN code received from the user matches with the defined PIN, the system may conclude that the transaction code received from the application residing in the mobile terminal of the recipient is correct and a corresponding amount can be output. The check of the amount of money to be output may be arranged similarly as described earlier by exchange of information between the at least one server 103 and the transaction device 101. The advantage of the use of PIN is that each user has his or her own code and it is easy to remember since the PIN code may be arranged to remain the same for a longer period. Additionally, the utilization of PIN enables the encryption of transaction related information so that even if a mobile terminal is stolen, the thief cannot withdraw the money only with the mobile terminal, as he or she cannot read the transaction code as a plain text. Even if the mobile terminal may carry the information on the PIN code, it requires time from the thief to decrypt the PIN into plain text. In the meanwhile the rightful owner of the mobile terminal may start necessary actions to disable the utilization of his or her PIN and thus prevent any misuse of the transaction.

In addition to applying the PIN code it may be required that some identification information is requested from the user of the transaction device 101. As already described the transaction device may comprise identification means coupled to the transaction device 101 for enabling the provision of the identification information. Alternatively or in addition, the mobile terminal of the user may be equipped with means of retrieving user information. For example, the mobile terminal of the user may comprise a camera or any similar scanning means, which can be utilized in the provision of identification information to the system by wired or wireless communication. It may be requested that the user of the mobile terminal takes an image on the identification card or similar with the camera of the mobile terminal and delivers that information to the system.

Alternatively or in addition, if an application for enabling the transaction as describe is downloaded and installed in the mobile terminal, it may be arranged that a predetermined identification data record is created in the mobile terminal, which is configured to be transferred to the system each time when a transaction as described is initiated or performed. Such a predetermined identification data record may e.g. comprise image of the user, image of any identification card, other user related personal information. As said the identification means may comprise any feature provided by the mobile terminal of the user or any external device, which may be coupled to the mobile terminal.

FIG. 3 illustrates principal steps of the method according to the invention. In the first phase the money transaction is initiated 301. The step of initiating the transaction 301 comprises mainly actions originated by a sender of the money. The initiation step may comprise a detection of money inserted into the transaction device 101. Furthermore, it may comprise an action to determine a value of inserted money and requesting an acceptance for the defined value from the sender. Additionally, the initiation step 301 may comprise an action of checking if the inserted money is counterfeit or not and any actions in case of counterfeit, as described earlier. Furthermore, the initiation step 301 may comprise an action of determining a transaction code for the initiated transaction. The determination may be performed by the system i.e. by the transaction device 101 with or without at least one server 103 belonging directly or indirectly to the system. In some implementation the sender may determine and insert a transaction code for the transaction by utilizing the I/O means of the transaction device 101. In some further embodiments the transaction code can be determined and inserted to the system through a mobile terminal of the sender over a communication channel established between the mobile terminal and the transaction device. In response to the determination of the transaction code the information on the transaction code and the amount of money for the transaction code is delivered to a server belonging to the system. The initiation step may also comprise any wireless communication with a mobile terminal of a sender as discussed earlier.

In step 303 the transaction information is managed within the system. The step comprises at least storing of information defined in the initiation step 301 in the system. Additionally, if the system is implemented so that the system requests any contact detail of any party of the transaction i.e. sender or recipient of the money, the step 303 may comprise an operation of composing a message to at least one party of the transaction and initiating a delivery of the message through a telecommunication connection. The management of transaction information 303 may also comprise an operation of monitoring time with respect to any transaction information stored in the system. More specifically, this means that a time limit may be set in the system during which the money shall be withdrawn from the system. This may comprise an operation of sending reminder message to at least one of the parties of the transaction when the time limit is met. Alternatively or in addition, the step of management of transaction information may comprise an action in which the system is configured to change access rights for the transaction if e.g. a predetermined time limit is exceeded. For example, it may be arranged that if the money is not withdrawn by the recipient during the time limit, the system may add an indicator, such as changing a state of an information bit, to indicate that a sender of the money is also entitled to withdraw the money. Additionally, a new time limit may be set for withdrawal. Furthermore, the step of management of transaction information 303 may comprise actions relating to storing and utilizing PIN codes as described.

According to the method of the invention a step of termination of transaction 305 comprises actions relating to the withdrawal of the money. The step may comprise e.g. an operation of receiving a transaction code in a transaction device 101. The receipt of the transaction code may be implemented by receiving the code from the recipient who has inserted the code by I/O means of the transaction device 101. Alternatively or in addition, the receipt of transaction code may comprise communication between the transaction device 101 and a mobile terminal of the recipient. For example, the transaction device 101 may be configured to deliver information on the received transaction code to the at least one server 103 belonging to the system in step 305. The termination of transaction 305 may also comprise an action of requesting if there exists a corresponding transaction code as the inserted one in the system, e.g. in a server. If a match is found, the termination of transaction 305 may comprise composing an acknowledge message inside the system and delivering the acknowledge message from at least one server 103 to the transaction device 101. Additionally, information on the amount of money stored in the context of the transaction code in the at least one server 103 may be delivered in the acknowledge message or any separate message. The termination of the transaction 305 may comprise an action of determining the amount of money indicated in a message and outputting the determined amount of money in the transaction device 101. The termination of transaction may further comprise deletion of information as regards the completed transaction. Alternatively or in addition, information on the completed transaction may be stored in the system for any later need.

Even if the operations belonging to the method according to the invention are divided into the steps 301, 303, 305 according to FIG. 3, it is clear that the operations are not anyhow tied to the mentioned steps. It depends on the implementation if some operation is performed in any other step than described. Further, the steps as described in the context of FIG. 3 may comprise further steps and operations as described in the description of the system.

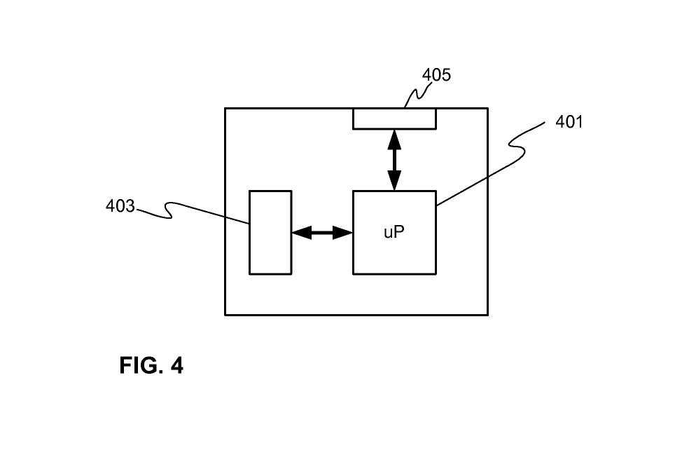

Above it is mainly described that only one server 103 is arranged to participate in the money transaction. However, it may be arranged that more than one server participate to the transaction. For example, the invention may be implemented so that one server is configured to maintain information on pending transaction whereas another server is configured to store user related information, such as PIN code information, or store information on the completed transaction in a long term. A server according to the invention, as illustrated in FIG. 4, typically comprises processing element, such as at least one processor, at least one memory element 403, such as RAM and/or ROM, and necessary interfaces 405 for internal and external communication and inputting and outputting of information. Additionally, the server 103 may comprise software stored in the memory means for providing operation instructions for the server and any other entity, when at least piece of software is executed by the processing means of the server 103. The at least one memory element 403 of the server 103 may comprise data structure, which enable storing and retrieving transaction related information as described above.

The communication between at least one transaction device 101 and at least one server can be implemented by utilizing any wired and wireless communication channels and networks. For example, coupling the mentioned elements with necessary security related solutions together over the Internet is a feasible implementation.

According to the invention the money transaction i.e. the insertion of money and operations thereto and the withdrawal of money and operations thereto may be performed in the same transaction device 101 or in different transaction devices 101. This is merely dependent on the locations of the sender and recipient of the money. Further, it may be arranged that the sender of the money may set limitations to the withdrawal of money during the initiation of the transaction. The transaction device 101 may be arranged to request any limitation with respect to the withdrawal from the sender. For example, if parents insert an amount of money for their child, it would be advantageous, at least in some cases, that the child is capable of withdrawing the money at once. The parents may set a maximum amount for one withdrawal, or they may set that the whole amount shall be withdrawn in multiple withdrawals during a certain period. Such information received from the sender is advantageously stored in the context of the transaction and is to be stored in the at least one server 103. The stored limitations are configured to be checked e.g. when the withdrawal (e.g. a transaction code) request is received.

Here it is used a term ‘money’ in referring to an item having a value, which value is transferred between the sender and the recipient. The term ‘money’ shall be understood to cover any similar items, such as cheques and vouchers, which have value. Additionally, the validity and value of those can be evaluated by some means and the value can be transferred over telecommunication network and output by the recipient by some means.

Some advantageous embodiments according to the invention were described above. The invention is not limited to the embodiments described. The inventive idea can be applied in numerous ways within the scope defined by the claims attached hereto.

1. A system for providing money transaction between a sender and a recipient, comprising:
at least one transaction device (101)
at least one server (103) for maintaining money transaction related information
characterized in that within the system the at least one transaction device (101) is configured to:
receive money inserted in the transaction device (101) by a sender
determine the value of the inserted money
determine a transaction code for the inserted money
deliver information on at least the value of the inserted money and the determined transaction code to the at least one server (103), which is configured to create a data record for the money transaction and to maintain money transaction related information,
and within the system at least one transaction device (101) is further configured to:
receive a transaction code from a recipient
request, by delivering the received transaction code to the at least one server (103) maintaining money transaction related information, if a corresponding transaction code with information on the value of inserted money is stored in the at least one server (103), and if a match is found
receive, from the at least one server (103) in response to the request, an authorization to output a corresponding amount of money in cash as indicated in the information in the server (103) in connection to the transaction code output the corresponding amount of money in the transaction device (101).

2. A system according to claim 1, characterized in that the at least one transaction device is further configured to output the determined transaction code to the sender by means of I/O means of the at least one transaction device in response to the determination of the transaction code.

3. A system according to claim 1, characterized in that the determination of the transaction code comprises one of the following: creation of the transaction code in the transaction device (101), creation of the transaction code in the at least one server (103), receipt of the transaction code from the sender by means of I/O means of the transaction device (101), receipt of the transaction code from a mobile terminal of the sender over a communication channel between the mobile terminal and the transaction device (101).

4. A system according to claim 1, characterized in that the transaction device (101) further comprises a counterfeit detection means (215) for checking if the inserted money is counterfeit or not during the step of determination the value of the inserted money.

5. A system according to claim 1, characterized in that the transaction device (101) further comprises an interface for communicating wirelessly with a mobile terminal.

6. A system according to claim 5, characterized in that the transaction code is configured to be wirelessly transferred from the transaction device (101) to the mobile terminal of the sender.

7. A system according to claim 5, characterized in that the transaction code is configured to be wirelessly transferred to the transaction device (101) from the mobile terminal of the recipient.

8. A system according to claim 5, characterized in that the communication between the transaction device (101) and the mobile terminal is arranged to be encrypted.

9. A system according to claim 1, characterized in that the at least one server is further configured to store user related PIN arranged to be used in money transaction.

10. A system according to claim 1, characterized in that the transaction device (101) is configured to deliver a confirmation message to the at least one server (103) in response to output of the money.

11. A system according to claim 10, characterized in that the at least one server (103) is configured to delete information relating to the completed transaction stored in a memory of the server (103) in response to a receipt of the confirmation message.

12. A system according to claim 10, characterized in that the at least one server (103) is configured to store information on the completed transaction.

13. A system according to claim 1, characterized in that the at least one server (103) is further configured to check if the same transaction code already exist in the server (103) as sent by a transaction device (101) in the context of delivery of transaction information.

14. A system according to claim 13, characterized in that the at least one server (103) is configured to request a re-determination of the transaction code (103) from the transaction device (101) delivering the transaction related information if the match is found.

15. A system according to claim 1, characterized in that the transaction device is configured to request at least one of the following from the sender: sender's contact detail, recipient's contact detail.

16. A system according to claim 15, characterized in that the system is configured to deliver a message to at least the sender or the recipient of money if a predetermined time limit for withdrawal of the money is exceeded.

17. A system according to claim 1, characterized in that the transaction device (101) comprises identification means for receiving at least some identification information on the user of the transaction device (101) to be stored in a context of the transaction related information.

18. A method for providing money transaction between a sender and a recipient, characterized in that the method comprises at least the following steps during the initiation of transaction (301):
receiving money inserted in a transaction device (101) by a sender
determining the value of the inserted money
determining a transaction code for the inserted money
delivering information on at least the value of the inserted money and the determined transaction code to at least one server (103), which is configured to create a data record for the money transaction and to maintain money transaction related information,
and the following steps during the termination of transaction (305):
receiving a transaction code from a recipient
requesting, by delivering the received transaction code to the at least one server (103) maintaining money transaction related information, if a corresponding transaction code with information on the value of inserted money is stored in the at least one server (103), and if a match is found
receiving, from the at least one server (103) in response to the request, an authorization to output a corresponding amount of money in cash as indicated in the information in the server (103) in connection to the transaction code outputting the corresponding amount of money in a transaction device (101).

19. A method according to claim 18, characterized in that the method comprises a step of outputting the determined transaction code to the sender by means of I/O means of the at least one transaction device in response to the determination of the transaction code.

20. A method according to claim 18, characterized in that the determination of the transaction code comprises one of the following: creating the transaction code in the transaction device (101), creating the transaction code in the at least one server, receiving the transaction code from the sender by means of I/O means of the transaction device (101), receiving the transaction code from a mobile terminal of the sender over a communication channel between the mobile terminal and the transaction device (101).

21. A method according to claim 18, characterized in the method further comprises a step of checking if the inserted money is counterfeit or not.

22. A method according to claim 18, characterized in that the method further comprises wireless communication between the transaction device (101) and a mobile terminal.

23. A method according to claim 22, characterized in that the transaction code is wirelessly transferred from the transaction device (101) to the mobile terminal of the sender.

24. A method according to claim 22, characterized in that the transaction code is wirelessly transferred to the transaction device (101) from the mobile terminal of the recipient.

25. A method according to claim 22, characterized in that the communication between the transaction device (101) and the mobile terminal is encrypted.

26. A method according to claim 18, characterized in that a user related PIN arranged to be used in money transaction is stored in the at least one server (103) in a step of management of transaction information.

27. A method according to claim 18, characterized in that in the step of management of transaction information delivering a confirmation message to the at least one server (103) in response to output of the money.

28. A method according to claim 27, characterized in that the method comprises a further step of deleting information relating to the completed transaction stored in a memory of the server (103) in response to a receipt of the confirmation message.

29. A method according to claim 27, characterized in that that the method comprises a further step of storing information on the completed transaction.

30. A method according to claim 18, characterized in that the method further comprises a step of checking, by the at least one server (103), if the same transaction code already exist in the server (103) as sent by a transaction device (101) in the context of delivery of transaction information.

31. A method according to claim 30, characterized in that the method further comprises a step of requesting, by the at least one server (103), a re-determination of the transaction code (103) from the transaction device (101) delivering the transaction related information if the match is found.

32. A method according to claim 18, characterized in that the method further comprises a step of requesting, by the transaction device (101), at least one of the following from the sender: sender's contact detail, recipient's contact detail.

33. A method according to claim 32, characterized in that the method further comprises a step of delivering a message to at least the sender or the recipient of money if a predetermined time limit for withdrawal of the money is exceeded.

34. A method according to claim 18, characterized in that the method further comprises a step of receiving at least some identification information on the user of the transaction device (101) to be stored in a context of the transaction related information by means of identification means of the transaction device (101).
